(19) United States
(12) Patent Application Publication
(10) Pub. No.: US 2017/0076078 A1
(43) Pub. Date: Mar. 16, 2017

(54) USER AUTHENTICATION METHOD, DEVICE FOR EXECUTING SAME, AND RECORDING MEDIUM FOR STORING SAME

(71) Applicant: Ho KIM, Seoul (KR)

(72) Inventor: Ho KIM, Seoul (KR)

(21) Appl. No.: 15/309,278

(22) PCT Filed: Apr. 22, 2015
(86) PCT No.: PCT/KR2015/004006

§ 371 Date: Nov. 7, 2016

(30) Foreign Application Priority Data
May 12, 2014 (KR) 10-2014-0056802

(51) Int. Cl. G06F 21/32; G06K 9/46; G06K 9/00

(52) U.S. Cl. CPC G06F 21/32; G06K 9/00255; G06K 9/00288; G06K 9/4604

(57) ABSTRACT

The present invention relates to a user authentication method, a device for executing the same, and a recording medium for storing the same. A user authentication method executed in a user authentication device according to an embodiment of the present invention comprises: a step of, when image data of a user is received from an image photographing device, detecting a facial area and a facial feature point using each frame image of the image data; a step of performing a face authentication by matching the facial area with a predetermined face template; a password authentication step of detecting an eye winking using an image of an eye area extracted using the facial feature point, recognizing a password according to a state of the eye winking on the basis of a preconfigured reference, and checking whether the recognized password matches with a preconfigured password; and a step of determining that the user authentication is successful, on the basis of the results obtained from the face authentication and the password authentication.

### TECHNICAL FIELD

Embodiments of the present invention generally relate to a user authentication method, a device for performing the method, and a recording medium for storing the method.

### BACKGROUND ART

Unlike other biometric recognition technologies, face recognition technology has an advantage in that recognition may be naturally performed in a contactless manner without requiring special motion or activity on the part of a user, and may thus be regarded as the most excellent biometric recognition technology from the standpoint of the user.

The application of such face recognition technology has expanded to various fields, and has attracted attention in a security authentication field, for example.

When face recognition is applied to security authentication, automatic authentication may be performed merely by gazing at a camera, without requiring the input of a password or the use of an additional authentication medium, and may prevent the personal information of a user from being illegally leaked due to the forgery, theft or loss of a password or an authentication medium.

For example, this technology has many useful advantages, such as preventing users from indiscriminately sharing IDs and passwords upon logging into a web service and thus minimizing the loss experienced by a website owner. In addition, this technology may be applied to various authentication fields, such as PC login, smart phone unlocking, and E-learning.

However, variation in recognition rate attributable to the rotation, expression, lighting, or aging of the face is a weakness generally appearing in face recognition technology, and the minimization of the error rate caused by this weakness has arisen as an issue.

In particular, reducing a False Accept Rate (FAR) in face recognition is one of the most important problems in applying face recognition to authentication fields.

As a solution to this, an approach to continuously improve face recognition performance while combining face recognition with another authentication scheme may be one such scheme. In this case, even if another person is accepted due to recognition error and authentication based on face recognition is passed, a dual security procedure may be performed, and thus near-perfect security authentication may be realized.

However, when face recognition is combined with an existing authentication scheme (password or USB authentication), security strength may be improved, but there is a disadvantage in that, from the standpoint of the user, the limitation of the existing authentication scheme still remains, thus making it impossible to satisfactorily utilize the advantage of face recognition.

As a result, there is required the development of technology capable of minimizing an authentication error rate via combination with face recognition while maintaining the advantage of face recognition.

### DISCLOSURE

### Technical Problem

An object of the present invention is to provide a user authentication method, a device for performing the method, and a recording medium for storing the method, which are configured to combine authentication based on a user's face included in an input image, with authentication based on a password recognized depending on the state of eye winking included in a facial area, thus simultaneously providing both convenience and accuracy of user authentication.

Another object of the present invention is to provide a user authentication method, a device for performing the method, and a recording medium for storing the method, which extract a change region between frame images using the difference between the frame images and perform face detection only in the change region, so that there is no need to perform a face detection operation on the entire area of each frame image, thus improving face detection speed for each frame image.

A further object of the present invention is to provide a user authentication method, a device for performing the method, and a recording medium for storing the method, which construct an image pyramid for a change region, process individual images on the image pyramid in a distributed processing manner, individually detect facial areas, aggregate the results of detection, and finally detect a facial area, thus improving the accuracy of detection of the facial area.

Objects to be achieved by the present invention are not limited to the above-described objects, and other object(s), not described here, may be clearly understood by those skilled in the art from the following descriptions.

### Technical Solution

Among embodiments, a user authentication method performed by a user authentication device includes when image data of a user is received from an imaging device, detecting a facial area and facial feature points using individual frame images in the image data; performing face authentication by matching the facial area with a specific face template; performing password authentication by detecting whether eye winking occurs using an image of an eye region extracted using the facial feature points, by recognizing a password depending on a state of eye winking based on preset criteria, and by determining whether the recognized password matches a preset password; and determining that authentication of the user succeeds based on results of the face authentication and results of the password authentication.

Among embodiments, a user authentication device, includes a facial area detection unit for, when image data of a user is received from an imaging device, detecting a facial area and facial feature points using individual frame images in the image data; a first authentication unit for performing face authentication by matching the facial area with a specific face template; a second authentication unit for detecting whether eye winking occurs using an image of an eye region extracted using the facial feature points, recognizing a password depending on a state of the eye winking based on preset criteria, and determining whether the recognized password matches a preset password; and a determination unit for determining that authentication of the user succeeds based on results of the authentication by the first authentication unit and results of the authentication by the second authentication unit.

Among embodiments, in a recording medium for storing a computer program for executing a user authentication method performed by a user authentication device, the computer program includes a function of, when image data of a user is received from an imaging device, detecting a facial area and facial feature points using individual frame images in the image data; a function of performing face authentication by matching the facial area with a specific face template; a password authentication function of detecting whether eye winking occurs using an image of an eye region extracted using the facial feature points, recognizing a password depending on a state of the eye winking based on preset criteria, and determining whether the recognized password matches a preset password; and a function of determining that authentication of the user succeeds based on results of the face authentication and results of the password authentication.

Details of other embodiments are included in the following detailed description and attached drawings.

The advantages and/or features of the present invention and methods for accomplishing them will be more clearly understood from the following detailed description taken in conjunction with the accompanying drawings. However, the present invention may be implemented in various forms without being limited to the following embodiments, and the present embodiments are merely intended to make the disclosure of the present invention complete and to completely notify those skilled in the art of the scope of the invention. Further, the present invention is merely defined by the scope of the accompanying claims. Throughout the specification, the same reference numerals are used to designate the same components.

### Advantageous Effects

According to the present invention, there is an advantage in that authentication based on a user's face included in an input image is combined with authentication based on a password recognized depending on the state of eye winking included in a facial area, thus simultaneously providing both convenience and accuracy of user authentication.

Further, according to the present invention, there is an advantage in that a change region between frame images is extracted using the difference between the frame images and face detection is performed only in the change region, so that there is no need to perform a face detection operation on the entire area of each frame image, thus improving face detection speed for each frame image. The improvement of such detection speed is profitable especially for application to terminals having limited computing resources, such as mobile devices.

Furthermore, according to the present invention, there is an advantage in that an image pyramid for a change region is constructed, individual images on the image pyramid are processed in a distributed processing manner, facial areas are individually detected, the results of detection are aggregated, and a facial area is finally detected, thus improving the accuracy of detection of the facial area.

### DESCRIPTION OF DRAWINGS

FIG. 1 is a block diagram showing a user authentication device according to an embodiment of the present invention;

FIG. 2 is a flowchart showing an embodiment of a user authentication method according to the present invention;

FIG. 3 is a flowchart showing another embodiment of a user authentication method according to the present invention;

FIG. 4 is a flowchart showing a further embodiment of a user authentication method according to the present invention;

FIG. 5 is a flowchart showing yet another embodiment of a user authentication method according to the present invention;

FIG. 6 is a reference diagram showing a procedure for detecting a facial area from a normal frame image using a key frame image;

FIG. 7 is a reference diagram showing a procedure for detecting a facial area by constructing an image pyramid of frame images;

FIG. 8 is a diagram showing rectangular features (symmetric and asymmetric features) for detecting a facial area;

FIG. 9 is a reference diagram showing a procedure for detecting a facial area using the rectangular features of FIG. 8; and

FIG. 10 is a reference diagram showing a procedure for detecting eye winking in the facial area.

### MODE FOR INVENTION

Hereinafter, embodiments of the present invention will be described in detail with reference to the attached drawings.

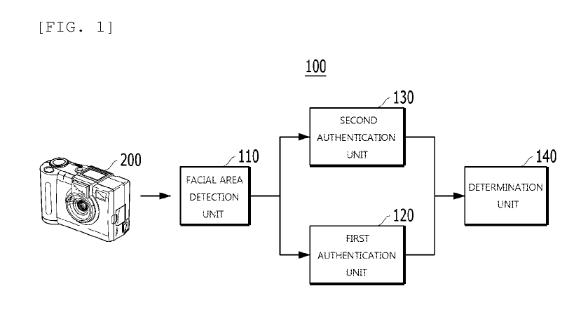

FIG. 1 is a block diagram showing a user authentication device according to an embodiment of the present invention.

Referring to FIG. 1, a user authentication device 100 includes a facial area detection unit 110, a first authentication unit 120, a second authentication unit 130, and a determination unit 140.

When image data of the user is received from an imaging device, the facial area detection unit 110 detects a facial area and facial feature points using each frame image contained in the image data. The facial area detection unit 110 provides information about the facial area and the facial feature points to the first authentication unit 120 and/or to the second authentication unit 130.

When a frame image is received from the imaging device, the facial area detection unit 110 detects a facial area from the frame image, and defines a specific frame image as a key frame image.

First, the facial area detection unit 110 sets a value, obtained by linearly coupling the brightness values of pixels neighboring each pixel in the frame image to filter coefficients, to the brightness value of the corresponding pixel, thus eliminating noise from the frame image.

Next, the facial area detection unit 110 generates multiple images having different sizes by down-scaling the frame image, detects candidate facial areas from respective multiple images, and detects a facial area from the corresponding frame image using an area common to the candidate facial areas.

For example, the facial area detection unit 110 may detect a facial area from the original frame image, detect a facial area from each frame image that is down-scaled from the original frame image, additionally detect a facial area from each frame image that is further down-scaled therefrom, and detect an area common to the facial areas that have been detected from the frame images for respective scales as a facial area in the corresponding frame. This method may be understood to be an image pyramid technique.

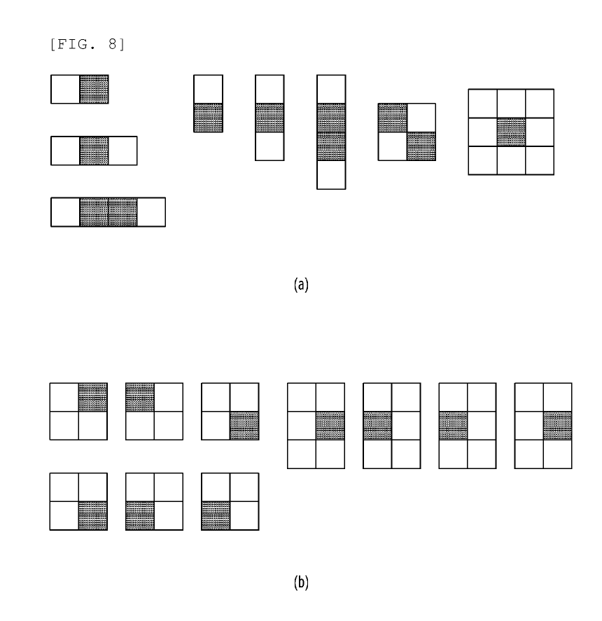

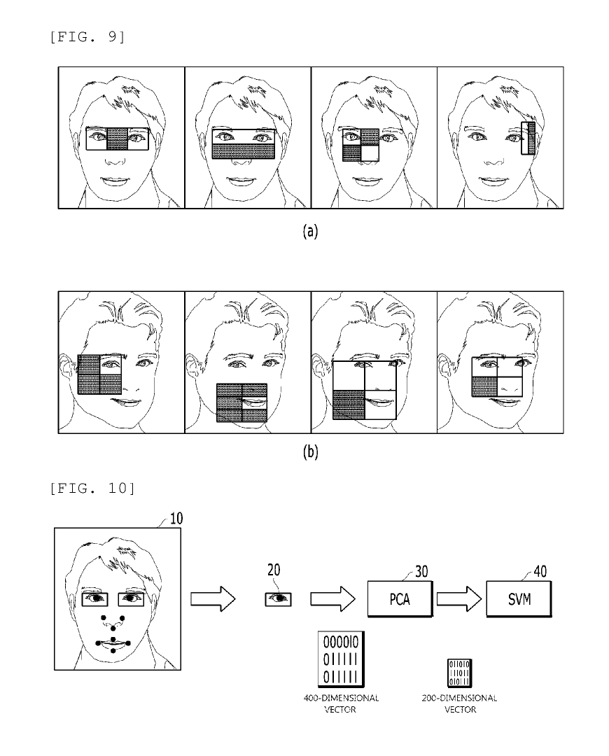

Here, the facial area detection unit 110 may detect facial areas and facial feature points (e.g. the eyes) from respective multiple images of a frame image using rectangular features (or a rectangular feature point model). A description related to the facial areas and facial feature points (e.g. the eyes) using rectangular features (or a rectangular feature point model) will be made in detail later with reference to FIGS. 8 and 9.

The facial area detection unit 110 may define a certain frame image as a key frame image if there is no remainder when the frame number of the frame image is divided by a specific number. For example, to update a key frame every 15-th frame, the facial area detection unit 110 may define a certain frame image as a key frame image if there is no remainder when the frame number of the frame image is divided by 15.

The facial area detection unit 110 defines the key frame image, receives normal frame images, extracts a change region from the normal frame images based on the key frame image, and detects facial areas from the normal frame images using the change region.

First, the facial area detection unit 110 compares the key frame image with each normal frame image, generates a difference frame image including information about the difference between the frames, performs thresholding and filtering on the difference frame image, and generates a binary frame image for the difference frame image.

More specifically, the facial area detection unit 110 compares the brightness values of respective pixels in the difference frame image with a threshold value, converts the corresponding pixel into a value of 255, that is, a white color, when the brightness value of the corresponding pixel is greater than the threshold value, and converts the corresponding pixel into a value of 0, that is, a black color, when the brightness value of the corresponding pixel is less than the threshold value, and thus generates a binary frame image. The threshold value may be stored in advance in the user authentication device 100.

Further, the facial area detection unit 110 eliminates noise by applying a filter to the binary frame image. For example, the facial area detection unit 110 may eliminate noise by transposing the brightness value of the pixel corresponding to noise in the binary frame image into the median value of the brightness values of neighboring pixels. Such a filter may be understood to be a kind of median filter.

Thereafter, the facial area detection unit 110 determines a face detection region from each normal frame image using the binary frame image. More specifically, the facial area detection unit 110 may extract rectangular regions including white pixels from the binary frame image, and may determine a final rectangular region including individual rectangular regions to be the face detection region. The term ‘face detection region’ may also be understood to be the concept of a ‘change region’ between frames for facial detection, from another standpoint.

Finally, the facial area detection unit 110 detects a facial area from the face detection region. More specifically, the facial area detection unit 110 may generate multiple images having different sizes by down-scaling the face detection region, detect candidate facial areas from respective multiple images, and detect a facial area from the corresponding frame image using an area common to the candidate facial areas.

Here, the facial area detection unit 110 may detect facial areas and facial feature points (e.g. the eyes, nose, mouth, etc.) from respective multiple images of the frame image using rectangular features. A detailed description related to the detection of facial areas and facial feature points using rectangular features will be made with reference to FIGS. 8 and 9.

The first authentication unit 120 performs face recognition by matching the facial area with a pre-stored specific face template. In an embodiment, the first authentication unit 120 calculates the similarity between the facial area and the face template by comparing the binary feature amount of the facial area with the binary feature amount of the pre-stored specific face template, and provides the results of face authentication based on the calculated similarity to the determination unit 140. The pre-stored specific face template is the face template of the user requiring authentication, and may be stored in advance in the user authentication device 100. ‘Matching’ between the facial area and the specific face template may be understood to have the same meaning as an operation of comparing the binary feature amount of the facial area with the binary feature amount of the pre-stored specific face template and calculating the similarity therebetween.

The second authentication unit 130 detects whether the winking of eyes occurs with reference to an eye region in the facial area, and determines whether a password, recognized depending on the state of eye winking, matches a preset password. The second authentication unit 130 provides the determination unit 140 with information about whether the password, recognized depending on the state of eye winking, matches the preset password.

The second authentication unit 130 may detect an eye region from the facial area using the facial feature points, generate a pixel vector having specific dimensions using the pixel values of the eye region, reduce the number of dimensions of the pixel vector by applying Principal Component Analysis (PCA) to the pixel vector, and detect whether eye winking occurs by applying a Support Vector Machine (SVM) to the pixel vector having the reduced number of dimensions.

The second authentication unit 130 extracts the password recognized depending on the state of eye winking. For example, the second authentication unit 130 may set recognition criteria in advance so that, when only the left eye is winking, the password is recognized as ‘0’, when only the right eye is winking, the password is recognized as ‘1’, and when both eyes are winking, the password is recognized as ‘2’, may extract the password input through the image based on the recognition criteria, and may then determine whether the extracted password matches the password, which is preset by and pre-stored in the user authentication device 100.

The determination unit 140 may determine that the authentication of the user succeeds based on the results of the authentication by the first authentication unit 120 and the results of the authentication by the second authentication unit 130. For example, when both the results of face authentication and the results of password authentication are determined to indicate successful authentication, it may be determined that user authentication succeeds.

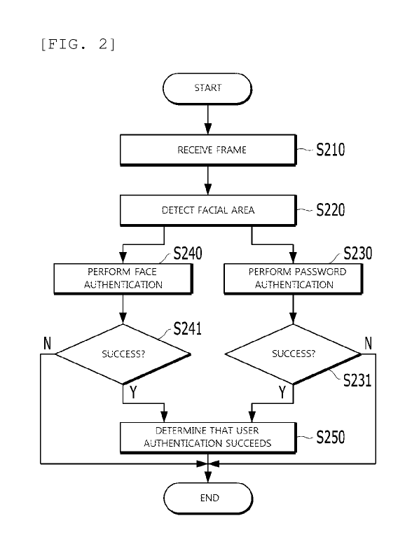

Hereinafter, a user authentication method will be described in detail with reference to FIGS. 2 to 5. Since the user authentication method, which will be described below, is performed by the above-described user authentication device 100, a repeated description of the corresponding components will be omitted, but those skilled in the art will understand the embodiments of the user authentication method according to the present invention from the above description.

FIG. 2 is a flowchart showing an embodiment of a user authentication method according to the present invention. The embodiment shown in FIG. 2 relates to an embodiment in which image data of a user is received and user authentication may be performed via both face authentication and password authentication.

Referring to FIG. 2, the user authentication device 100 receives image data of the user from the imaging device (step S210). The user authentication device 100 detects a facial area using a key frame image among frame images and normal frame images (step S220).

The user authentication device 100 detects whether eye winking occurs using an eye region of the facial area, and determines whether a password, recognized depending on the state of eye winking, matches a preset password (step S230).

In the example of step S230, the user authentication device 100 detects an eye region from the facial area using facial feature points, generates a pixel vector having specific dimensions using the pixel values of the eye region, and detects whether eye winking occurs using the pixel vector. Thereafter, a password, recognized depending on the state of eye winking, is extracted based on preset criteria. For example, the preset criteria are based on at least one of the state of winking of the left eye, the state of winking of the right eye, and the state of simultaneous winking of both eyes, and such winking states include at least one of the sequence of winking, the number of winking actions, the duration during which the corresponding eye is maintained in a closed or open state, and a combination of the winking of the left eye and the right eye.

For example, the second authentication unit 130 recognizes the password based on the criteria preset such that, when only the left eye is winking, the password is set to 0, when only the right eye is winking, the password is set to 1, and when both eyes are simultaneously winking, the password is set to 2, may extract the password input through the image based on the recognition criteria, and may then determine whether the recognized password matches the preset password.

The password may be set or recognized depending on the state of eye winking. For example, if the password is 0 when only the left eye is winking, is 1 when only the right eye is winking, and is 2 when both eyes are simultaneously winking, the user authentication device 100 set the password to ‘0102’ by winking the eyes in the sequence of the left eye, the right eye, the left eye, and both eyes. The number of digits of the password may be changed depending on settings, and the password for a specific user may be set and stored in advance.

The user authentication device 100 performs face authentication by matching the facial area with a specific face template (step S240).

The user authentication device 100 determines that authentication of the user succeeds when face authentication, performed at step S240, succeeds (step S241), and password authentication, performed at step S230, succeeds (step S231).

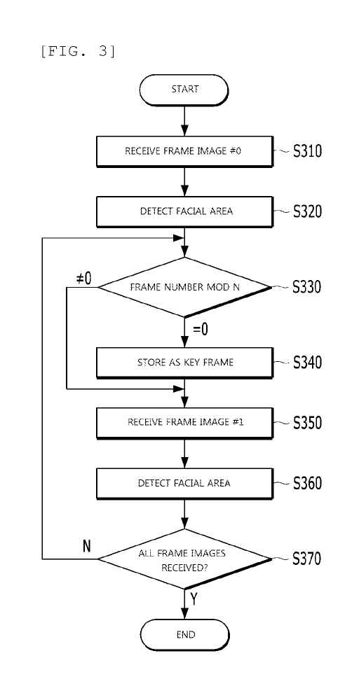

FIG. 3 is a flowchart showing another embodiment of a user authentication method according to the present invention. The embodiment shown in FIG. 3 relates to an embodiment in which a specific frame image among individual frame images in the image data of the user is processed and is determined to be a key frame image, and the facial area of a normal frame image that is subsequently input can be detected using the key frame image.

Referring to FIG. 3, the user authentication device 100 receives frame image #0 (the first frame image) (step S310). The user authentication device 100 detects a facial area from frame image #0 (step S320). Further, the frame image #0 is stored as an initial key frame image.

When it is determined that there is no remainder when the frame number of a subsequently input frame image is divided by a specific number (e.g. 15) (step S330), the user authentication device 100 updates the corresponding frame image to the key frame image and stores the updated key frame image (step S340). For example, in order to update the key frame every 15-th frame, the user authentication device 100 may be configured to, if there is no remainder when each frame number is divided by 15, define the corresponding frame image as a key frame image. For example, frame images #0, #15, #30, #45, . . . may be defined as key frame images. In the case of frame image #0, the remainder of 0/15 is 0, and thus frame image #0 may be stored as a key frame. Frame image #1, which is in a subsequent position, is processed as a normal frame image because the remainder of 1/15 is not 0. By way of this processing, frame image #15 may be stored as a new key frame because the remainder of 15/15 is 0. In the above description, the sequence, such as for #0 or #1, is a sequence assigned in the procedure for updating key frames for convenience of description, and another type of sequence or order may be assigned as long as the same results may be derived.

The user authentication device 100 receives frame image #1 (step S350). The user authentication device 100 detects a facial area from frame image #1 (step S360). The user authentication device 100 terminates the process if the reception of all frame images is completed (step S370).

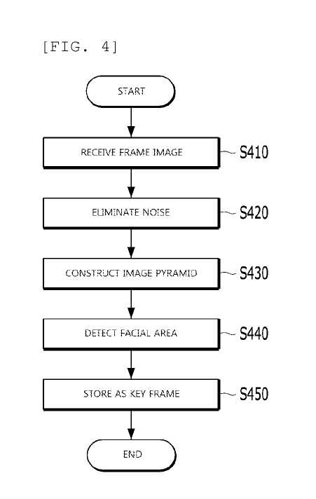

FIG. 4 is a flowchart showing a further embodiment of a user authentication method according to the present invention. The embodiment illustrated in FIG. 4 relates to an embodiment in which, among individual frame images in the image data of the user, a specific normal frame image, for example, a first input normal frame image, may be processed, and the corresponding frame image may be stored as a key frame image.

Referring to FIG. 4, the user authentication device 100 receives a first normal frame image among individual frame images in the image data (step S410).

The user authentication device 100 eliminates noise by applying a filter to the normal frame image (step S420). In the example of step S420, the user authentication device 100 sets a value, obtained by linearly coupling the brightness values of pixels neighboring each pixel in the normal frame image to filter coefficients, to the brightness value of the corresponding pixel, thus eliminating noise from the frame image. This procedure is given by the following Equation 1:

x′ᵢ=xᵢ₋₂c₀+xᵢ₋₁c₁+xᵢc₂+xᵢ₊₁c₃+xᵢ₊₂c₄ [Equation 1]

(x: frame number, i: pixel number, c: filter coefficient)

The user authentication device 100 constructs an image pyramid for the normal frame image (step S430). More specifically, the user authentication device 100 generates multiple images having different sizes by down-scaling the normal frame image.

The user authentication device 100 detects a facial area from the corresponding frame image using the image pyramid for the normal frame image (step S440). However, in the example of step S440, the user authentication device 100 detects candidate facial areas from respective multiple images having different sizes, which are generated by down-scaling the normal frame image, and may detect a facial area from the normal frame image using an area common to the candidate facial areas.

Here, the user authentication device 100 may detect facial areas and facial feature points (e.g. the eyes, nose, mouth, etc.) from respective multiple images using rectangular features.

The user authentication device 100 stores the normal frame image as the key frame image (step S450). For example, the data of the key frame image includes face detection data and image data. The face detection data includes the attributes of facial areas and the position attributes of facial feature points, and the image data includes the attributes of color models and the attributes of pixel data. The key frame image data is illustrated in an Extensible Markup Language (XML) format, as given by the following exemplary code:

```
[Exemplary code]
  < key_frame_data number= “frame number”>
  −< detection_data >
  <face_rect first= “upper left coordinate” last= “lower
right coordinate”/>
  <landmarks left_eye= “left eye coordinate” right_eye=
“right eye coordinate”... ... />
  </ detection_data >
  −< image_data >
  < color_model = “gray” />
  < pixel_data = “ ” />
  </ image_data>
  </ key_frame_data >
```

The <image_data> in the [exemplary code] includes color model attributes <color_model=“gray”/> and pixel data attributes <pixel_data=“ ”/> which correspond to the image pixel data of the key frame image. The image pixel data is used to extract a face detection region from the normal frame image.

FIG. 5 is a flowchart showing yet another embodiment of a user authentication method according to the present invention. The embodiment illustrated in FIG. 5 relates to an embodiment in which a facial area may be detected from a normal frame image using a key frame image among individual frame images in the image data of the user.

Referring to FIG. 5, the user authentication device 100 generates a difference frame image including information about the difference between the key frame image and the normal frame image by comparing the key frame image with the normal frame image (step S510).

The user authentication device 100 generates a binary frame image by performing thresholding on the difference frame image (step S520). In the example of step S520, the user authentication device 100 compares the brightness values of respective pixels in the difference frame image with a threshold value, converts the corresponding pixel into a value of 255, that is, a white color, when the brightness value of the corresponding pixel is greater than the threshold value, and converts the corresponding pixel into a value of 0, that is, a black color, when the brightness value of the pixel is less than the threshold value, and thus generates a binary frame image.

The user authentication device 100 eliminates noise by applying a filter to the binary frame image (step S530). In the example of step S530, the user authentication device 100 may eliminate noise by transposing the brightness value of the pixel corresponding to noise in the binary frame image into the median value of the brightness values of neighboring pixels.

The user authentication device 100 determines a face detection region from the normal frame image using the binary frame image (step S540). In the example of step S540, the user authentication device 100 extracts rectangular regions including white pixels from the binary frame image, and may determine a final rectangular region including individual rectangular regions to be the face detection region.

The user authentication device 100 constructs an image pyramid for the face detection region (step S550). In the example of step S550, the user authentication device 100 generates multiple images having different sizes by down-scaling the face detection region, thus constructing the image pyramid.

The user authentication device 100 detects a facial area from the corresponding frame image using the image pyramid for the face detection region (step S560).

In the example of step S560, candidate facial areas may be detected from respective multiple images, and the facial area may be detected using an area common to the detected candidate facial areas. Here, the user authentication device 100 may detect facial areas and facial feature points (e.g. the eyes, nose, mouth, etc.) from respective multiple images using the rectangular features.

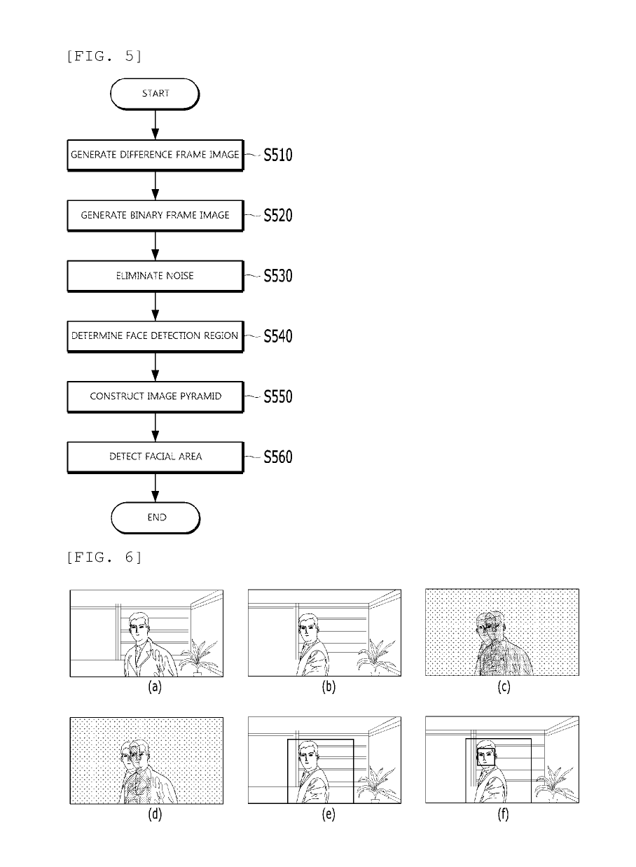

FIG. 6 is a reference diagram showing a procedure for detecting a facial area from a normal frame image using a key frame image.

Referring to FIG. 6, the user authentication device 100 generates a difference frame image including only information about the difference between frames, as shown in FIG. 6(c), by comparing the key frame image shown in FIG. 6(a) with the normal frame image shown in FIG. 6(b).

The user authentication device 100 generates a binary frame image, such as that shown in FIG. 6(d) by performing both thresholding and median filtering on the difference frame image shown in FIG. 6(c).

In an embodiment, the user authentication device 100 may perform thresholding by comparing the brightness values of respective pixels in the difference frame image of FIG. 6(c) with a threshold value, converting the corresponding pixel into a value of 255, that is, a white color, when the brightness value of the corresponding pixel is greater than the threshold value, and converting the corresponding pixel into a value of 0, that is, a black color, when the brightness value of the pixel is less than the threshold value.

The user authentication device 100 determines a face detection region from the normal frame image using the binary frame image of FIG. 6(d) (step S540).

In an embodiment, the user authentication device 100 extracts rectangular regions including white pixels from the binary frame image of FIG. 6(d), and determines a final rectangular region including the individual rectangular regions to be the face detection region. That is, the user authentication device 100 may determine the face detection region (change region) from the normal frame image, as shown in FIG. 6(e).

The user authentication device 100 detects a facial area, shown in FIG. 6(f), from the face detection region of FIG. 6(e).

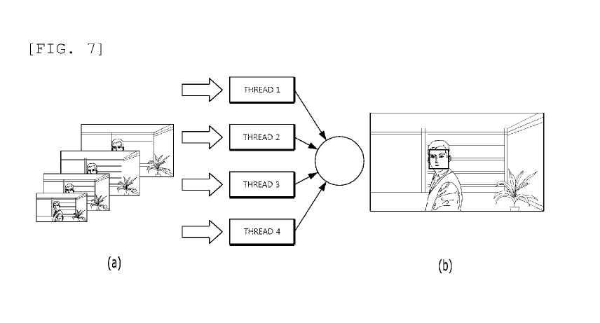

FIG. 7 is a reference diagram showing a procedure for detecting a facial area by constructing an image pyramid for the frame image.

Referring to FIG. 7, the user authentication device 100 generates multiple images having different sizes, such as those shown in FIG. 7(a), by down-scaling the normal frame image. The user authentication device 100 detects candidate facial areas from respective multiple images having different sizes, shown in FIG. 7(a). The user authentication device 100 may detect a facial area, as shown in FIG. 7(b), using an area common to the candidate facial areas detected from respective multiple images.

Meanwhile, when a facial area is detected from the normal frame image using a difference frame image between the key frame image and the normal frame image, the user authentication device 100 detects a face detection region from the normal frame image and generates multiple images having different sizes, as shown in FIG. 7(a), by down-scaling the face detection region.

The user authentication device 100 detects candidate facial areas from respective multiple images having different sizes, as shown in FIG. 7(a). The user authentication device 100 may detect a facial area, as shown in FIG. 7(b), using the area common to the candidate facial areas detected from the respective multiple images.

FIG. 8 is a diagram showing rectangular features (symmetric and asymmetric features) required to detect a facial area. FIG. 9 is a reference diagram showing a procedure for detecting a facial area using the rectangular features of FIG. 8. The rectangles illustrated in FIG. 8 or 9 may be understood to be features for facial area detection, and may be further understood to be symmetric Haar-like features (a), which desirably reflect the features of a front facial area, and asymmetric rectangular features (b), which are proposed to reflect the features of a non-front facial area.

Referring to FIGS. 8 and 9, when a specific frame among individual frames in image data is received from the imaging device 200 (see FIG. 1), the user authentication device 100 (see FIG. 1) detects a facial area and facial feature points (e.g. the eyes, nose, mouth, etc.) from the specific frame.

In an embodiment, the facial area detection unit 110 of the user authentication device 100 (see FIG. 1) detects candidate facial areas from respective frames in the image data, defines rectangular features (or a rectangular feature point model) for the detected candidate facial areas, and detects a facial area based on a learning material obtained by training the rectangular features using an AdaBoost learning algorithm, wherein a facial area in a rectangular shape may be detected. Further, the facial area detection unit 110 may detect facial feature points included in the detected facial area.

Generally, in frames including a front facial area, the unique structural features of the face, such as the eyes, the nose, and the mouth, are uniformly and widely distributed on the image and are also symmetrical. However, in frames including a non-front facial area, unique structural features of the face, such as the eyes, the nose, and the mouth, are not uniformly distributed on an image and are thus asymmetrical, and are concentrated in a small area. Further, the facial contour is not linear, and thus a significant background region coexists with the image.

Therefore, by further considering the fact that, when symmetrical features such as those shown in FIG. 8(a) are used, it may be difficult to obtain high detection performance for a non-front facial area, the present embodiment is configured to more preferably use not only the symmetric features shown in FIG. 8(a), but also the asymmetric features shown in FIG. 8(b). Unlike the symmetric features shown in FIG. 8(a), the asymmetric features shown in FIG. 8 (b) are implemented in an asymmetric shape, structure or form, and desirably reflect the structural features of a non-front face, thus realizing an excellent effect of detecting the non-front facial area. That is, by using symmetric features such as those shown in FIG. 8(a), a facial area may be detected from a frame such as that shown in FIG. 9(a), and by using asymmetric features such as those shown in FIG. 8(b), a facial area may be detected from a frame such as that shown in FIG. 9(b).

The detection of a facial area and the detection of facial feature points performed in this way may be implemented using a large number of well-known techniques. As an example, the detection of a facial area and the detection of facial feature points may be performed using an AdaBoost learning algorithm and an Active Shape Model (ASM). As another example, the detection of a facial area and the detection of facial feature points are described in detail in multiple papers and patent documents including Korean Patent Nos. 10-1216123 (Date of registration: Dec. 20, 2012) and 10-1216115 (Date of registration: Dec. 20, 2012) which were proposed by the present applicant, and thus a detailed description thereof will be omitted.

FIG. 10 is a reference diagram showing a procedure for detecting eye winking from a facial area.

Referring to FIG. 10, the user authentication device 100 detects an eye region from a facial area 10 using some feature points, for example, four feature points near the eye region, among facial feature points. Here, the image of the eye region is cropped to, for example, a bitmap, and rotational correction is performed, and thereafter the image is converted into a monochrome image 20 having a 20*20 pixel size. The user authentication device 100 performs histogram normalization on the monochrome image 20 of the eye region. For example, the user authentication device 100 generates a 400-dimensional pixel vector using the pixel values (20*20) of the monochrome image 20 of the eye region.

The user authentication device 100 acquires a pixel vector having a reduced number of dimensions corresponding to 200-dimensions by applying Principal Component Analysis (PCA) 30 to the 400-dimensional pixel vector, and inputs the reduced pixel vector to a Support Vector Machine (SVM) 40. In this way, when the number of dimensions of data to be input to the SVM 40 is reduced using the PCA, identification speed using the SVM 40 may be improved, and the size of a database including both support vectors and coupling coefficients may be greatly reduced. The user authentication device 100 may configure, for example, a 200-dimensional reduced input vector, and may detect whether eye winking occurs using the discriminant function of the SVM 40.

Embodiments of the present invention include computer-readable recording media having computer program instructions for performing operations implemented on various computers. The computer-readable recording media may include program instructions, data files, data structures, etc. alone or in combination. The media may be designed or configured especially for the present invention, or may be well-known to and used by those skilled in the art of computer software. Examples of the computer-readable recording media may include magnetic media such as a hard disk, a floppy disk, and magnetic tape, optical media such as Compact Disk-Read Only Memory (CD-ROM), a Digital Versatile Disk (DVD), and a Universal Serial Bus (USB) Drive, magneto-optical media such as a floptical disk, and hardware devices especially configured to store and execute program instructions, such as ROM, Random Access Memory (RAM), and flash memory. Meanwhile, such a recording medium may be a transfer medium such as light, a metal wire or a waveguide including carrier waves for transmitting signals required to designate program instructions, data structures, etc. Examples of program instructions include not only machine language code created by compilers, but also high-level language code that can be executed on computers using interpreters or the like.

As described above, although the present invention has been described with reference to a limited number of embodiments and drawings, the present invention is not limited to the above embodiments, and those skilled in the art will appreciate that various changes and modifications are possible from the description. Therefore, the spirit of the present invention should be defined by the accompanying claims, and uniform or equivalent modifications thereof should be construed as being included in the scope of the spirit of the present invention.

1. A user authentication method performed by a user authentication device, comprising:
when image data of a user is received from an imaging device, detecting a facial area and facial feature points using individual frame images in the image data;
performing face authentication by matching the facial area with a specific face template;
performing password authentication by detecting whether eye winking occurs using an image of an eye region extracted using the facial feature points, by recognizing a password depending on a state of eye winking based on preset criteria, and by determining whether the recognized password matches a preset password; and
determining that authentication of the user succeeds based on results of the face authentication and results of the password authentication.

2. The user authentication method of claim 1, wherein the detecting the facial area and facial feature points using individual frame images in the image data comprises:
detecting a facial area from a specific frame image among the frame images, and defining the specific frame image as a key frame image; and
extracting a change region from a normal frame image based on the key frame image, and detecting a facial area from the normal frame image using the change region.

3. The user authentication method of claim 2, wherein the detecting the facial area from the specific frame image among the frame images and defining the specific frame image as the key frame image comprises:
setting a value, obtained by linearly coupling brightness values of pixels neighboring each pixel in the specific frame image to filter coefficients, to a brightness value of a corresponding pixel, thus eliminating noise from the specific frame image.

4. The user authentication method of claim 2, wherein the detecting the facial area from the specific frame image among the frame images and defining the specific frame image as the key frame image comprises:
determining the specific frame image to be a key frame image if there is no remainder when a frame number of the specific frame image is divided by a specific number.

5. The user authentication method of claim 2, wherein the extracting the change region from the normal frame image based on the key frame image and detecting the facial area from the normal frame image using the change region comprises:
generating a difference frame image including information about a difference between the key frame image and the normal frame image by comparing the key frame image with the normal frame image;
generating a binary frame image for the difference frame image by performing thresholding on the difference frame image;
eliminating noise by applying a filter to the binary frame image;
determining a face detection region from the normal frame image using the binary frame image; and
detecting a facial area from the face detection region.

6. The user authentication method of claim 5, wherein the generating the binary frame image for the difference frame image by performing thresholding on the difference frame image comprises:
comparing brightness values of respective pixels in the difference frame image with a threshold value;
converting a corresponding pixel into a white color when a brightness value of the pixel is greater than the threshold value; and
converting the corresponding pixel into a black color when the brightness value of the pixel is less than the threshold value.

7. The user authentication method of claim 6, wherein the eliminating the noise by applying the filter to the binary frame image comprises:
transposing a brightness value of a pixel corresponding to noise in the binary frame image into a median value of brightness values of neighboring pixels.

8. The user authentication method of claim 6, wherein the determining the face detection region from the normal frame image using the binary frame image comprises:
extracting rectangular regions including a white pixel from the binary frame image; and
determining a final rectangular region including individual rectangular regions to be the face detection region.

9. The user authentication method of claim 5, wherein the detecting the facial area from the face detection region comprises:
generating multiple images having different sizes by down-scaling the face detection region;
detecting candidate facial areas from respective multiple images; and
detecting a facial area from the corresponding frame image using an area common to the candidate facial areas detected from respective multiple images.

10. The user authentication method of claim 9, wherein the detecting the facial area from the face detection region comprises:
detecting candidate facial areas from respective multiple images, defining rectangular features for the detected candidate facial areas, and detecting a facial area based on a learning material obtained by training the rectangular features using an AdaBoost learning algorithm; and
detecting facial feature points from the detected facial area based on an Active Shape Model (ASM) technique.

11. The user authentication method of claim 1, wherein the performing the face authentication comprises:
calculating a similarity by comparing a binary feature amount of the facial area with a binary feature amount of a pre-stored specific face template, and outputting the results of the face authentication based on the calculated similarity.

12. The user authentication method of claim 1, wherein the detecting whether eye winking occurs using the image of the eye region extracted using the facial feature points, the recognizing the password depending on the state of eye winking, and the determining whether the recognized password matches the preset password comprises:
extracting an eye region from the facial area using facial feature points;
generating a pixel vector having specific dimensions using pixel values of the eye region;
reducing a number of dimensions of the pixel vector using Principal Component Analysis (PCA); and
detecting whether eye winking occurs by applying a Support Vector Machine (SVM) to the pixel vector having the reduced number of dimensions.

13. The user authentication method of claim 1, wherein the preset criteria are based on at least one of a state of winking of a left eye, a state of winking of a right eye, and a state of simultaneous winking of both eyes, and the state of winking includes at least one of a sequence of winking, a number of winking actions, a duration during which the corresponding eye is maintained in a closed or open state, and a combination of winking of the left eye and the right eye.

14. A user authentication device, comprising:
a facial area detection unit for, when image data of a user is received from an imaging device, detecting a facial area and facial feature points using individual frame images in the image data;
a first authentication unit for performing face authentication by matching the facial area with a specific face template;
a second authentication unit for detecting whether eye winking occurs using an image of an eye region extracted using the facial feature points, recognizing a password depending on a state of the eye winking based on preset criteria, and determining whether the recognized password matches a preset password; and
a determination unit for determining that authentication of the user succeeds based on results of the authentication by the first authentication unit and results of the authentication by the second authentication unit.

15. A recording medium for storing a computer program for executing a user authentication method performed by a user authentication device, the computer program comprising:
a function of, when image data of a user is received from an imaging device, detecting a facial area and facial feature points using individual frame images in the image data;
a function of performing face authentication by matching the facial area with a specific face template;
a password authentication function of detecting whether eye winking occurs using an image of an eye region extracted using the facial feature points, recognizing a password depending on a state of the eye winking based on preset criteria, and determining whether the recognized password matches a preset password; and
a function of determining that authentication of the user succeeds based on results of the face authentication and results of the password authentication.
